(19) United States
(12) Patent Application Publication
(10) Pub. No.: US 2007/0108681 A1
(43) Pub. Date: May 17, 2007

(54) Bicycle rear suspension and damping system

(75) Inventors: Raymond P. Rhodes, Woodinville, WA (US); Charles Bragg, Bothell, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Rhodes and Bragg LLC, Woodinville, WA (US)

(21) Appl. No.: 11/280,649

(22) Filed: Nov. 16, 2005

(51) Int. Cl. F16F 1/14

(52) U.S. Cl. 267/273

(57) ABSTRACT

A rotary suspension system includes a housing and a first suspended component affixed to the housing. A shaft is rotatably mounted in the housing, and a second suspended component is affixed to the shaft. The first cam member may be affixed for rotational movement with the shaft and axial movement along the shaft. A mating cam is associated with the housing to cause axial movement of the first cam along the shaft as the shaft is rotated. A biasing element is mounted in the housing and coacts with the first cam to resiliently resist axial movement of the cam mounted on the shaft upon rotation of the shaft in one direction.

### FIELD OF THE INVENTION

The present invention relates to suspension mechanisms, more particularly to suspension mechanisms for a wheel, and most particularly to suspension mechanisms for the rear wheel of a bicycle.

### BACKGROUND OF THE INVENTION

A variety of suspension mechanisms for bicycles are available. All have their meritable aspects; however, many are complex, hard to service, not durable, or otherwise not satisfactory for bicycle use. A suspension mechanism that is easily installed and serviced is desirable.

### SUMMARY OF THE INVENTION

The present invention provides a simple, serviceable mechanism that can be easily assembled, serviced, and used. The suspension system is a rotary system comprising a housing and a first suspended component affixed to the housing. In a preferred embodiment, this first suspended component would be the forward portion of the frame of a bicycle. A shaft is rotatably mounted in the housing, and a second suspended component is affixed to the shaft. In a preferred embodiment, the second suspended component would be the rear arm supporting the rear wheel of a bicycle. A first cam is mounted on the shaft. A mating cam is associated with the housing for causing axial movement of one of the cams relative to the shaft within the housing. One of the mating cam and the first cam is mounted for axial movement when the first cam rotates with the shaft. A biasing element is mounted in the housing and coacts with the axially movable cam to resiliently resist axial movement of the mating cam upon rotation of the first cam. In a preferred embodiment, the biasing element is a plurality of Belleville washers or springs.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of a bicycle incorporating the suspension mechanism of the present invention;

FIG. 2 is a simplified schematic model of the suspension mechanism of the present invention;

FIG. 3 and FIG. 4 are isometric views of a preferred form of the housing incorporating the suspension mechanism of the present invention;

FIG. 5 and FIG. 6 are exploded isometric views of the components of the suspension mechanism of the present invention looking from the right and from the left, respectively; and

FIG. 7 is a longitudinal, cross-sectional view of an assembled suspension mechanism of the present invention.

### DETAILED DESCRIPTION OF THE PREFERRED EMBODIMENT

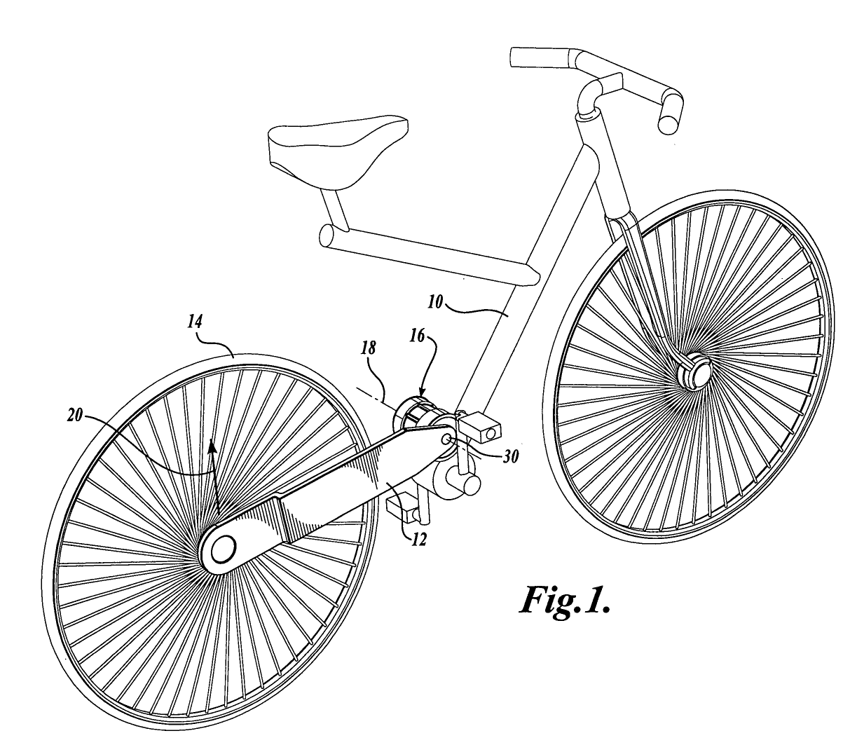

Referring first to FIG. 1, the schematic of the bicycle includes a main frame 10 that supports a fork and front wheel, a rear suspension arm 12 that supports a rear wheel 14, and a suspension hub 16. The suspension hub is affixed in a conventional manner to the main frame 10. The suspension arm is mounted on a shaft 30 for rotation about a transverse axis 18 through the hub 16. An internal suspension mechanism biases the suspension arm 12 toward a home position. When weight is placed on the bicycle frame or when an obstacle is encountered by the wheel 14, the suspension arm angulates upwardly in the direction of arrow 20 relative to hub 16 and the mainframe 10. When the weight or obstacle is removed, the suspension mechanism resiliently returns the arm 12 to its home position.

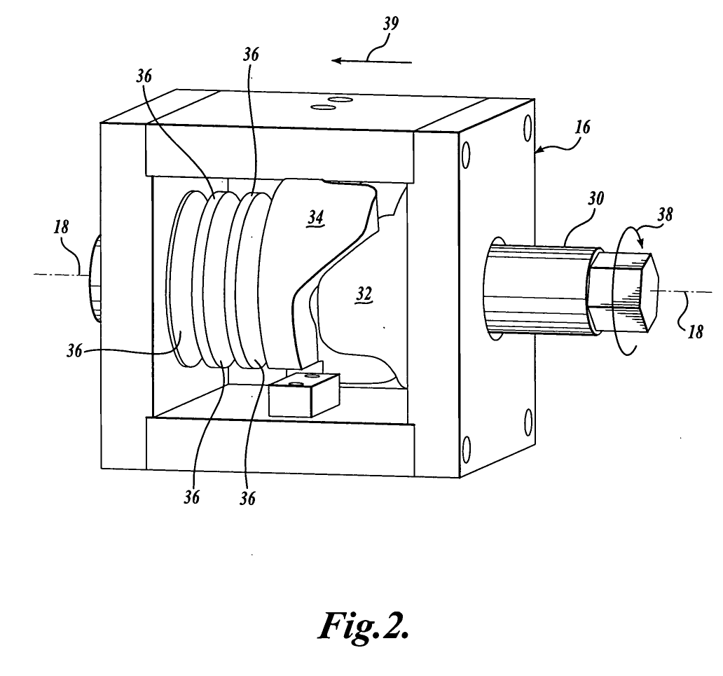

Referring to FIG. 2, a schematic of the hub and biasing structure is shown in simplified form. A shaft 30 is mounted for rotation in the hub 16 for rotation about the axis 18. A cam 32 is attached to the inner end of the shaft 30 and mates with a corresponding cam 34. Cam 34 is mounted to the frame so that it cannot rotate, but so that it can move axially along the axis 18 on the internal portion of the shaft 30. Frustoconically-shaped spring washers 36 (also known as Belleville washers or springs) are stacked between the axially movable cam 34 and the left-hand interior end wall of the hub 16. As the shaft 30 is rotated clockwise in the direction of arrow 38, cam 32 rotates in a clockwise direction with the shaft 30. Cams 32 and 34 interact so that cam 34 is moved axially away from cam 32 in the direction of arrow 39 along the axis 18 against the biasing force of the Belleville washers 36. Once the torque that caused rotation of the shaft 30 in a clockwise direction is relieved, the cam 34 will be moved axially in a direction opposite to arrow 39 along the axis 18 by the biasing force of the Belleville washers 36. The coaction of the cams 32 and 34 then will cause the rotation of the cam 32 and thus the shaft 30 in a counterclockwise direction opposite to arrow 38, thus causing a suspension arm connected to shaft 30 to swing to a home position.

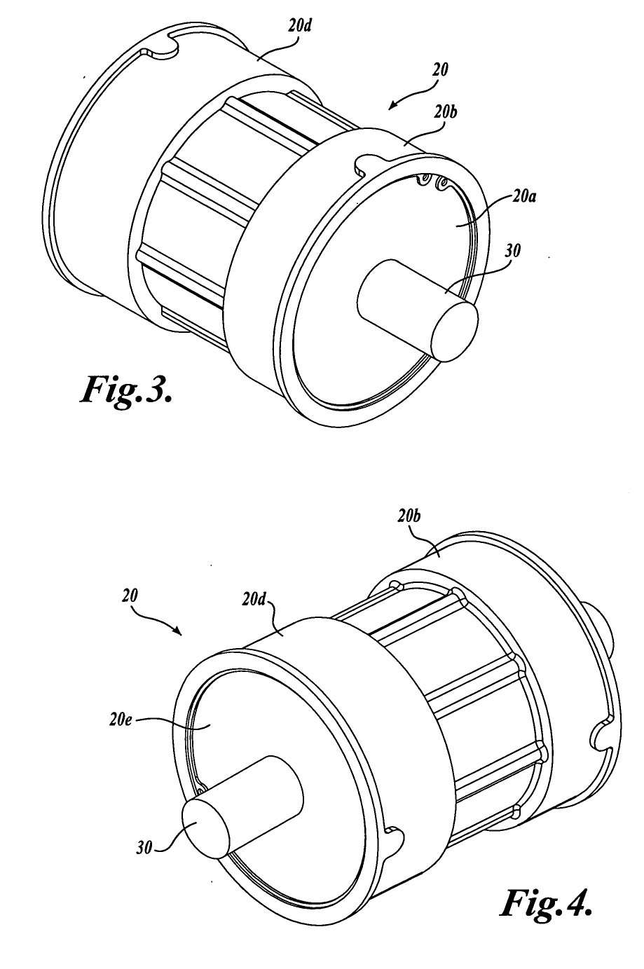

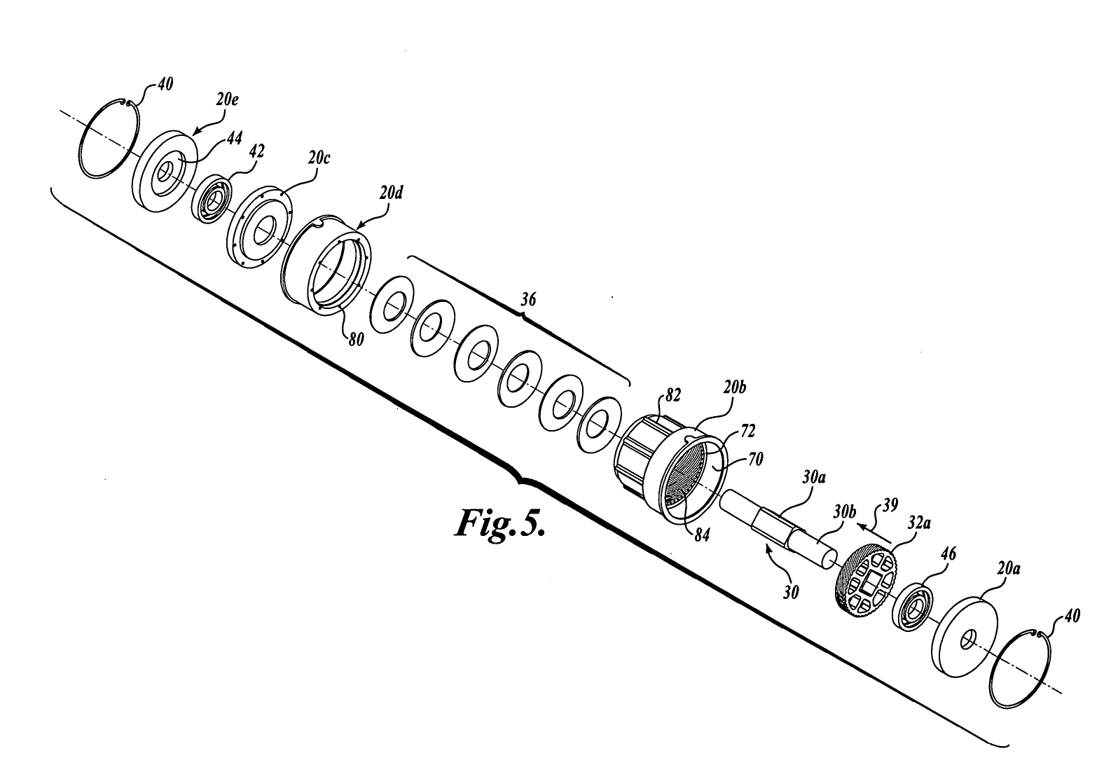

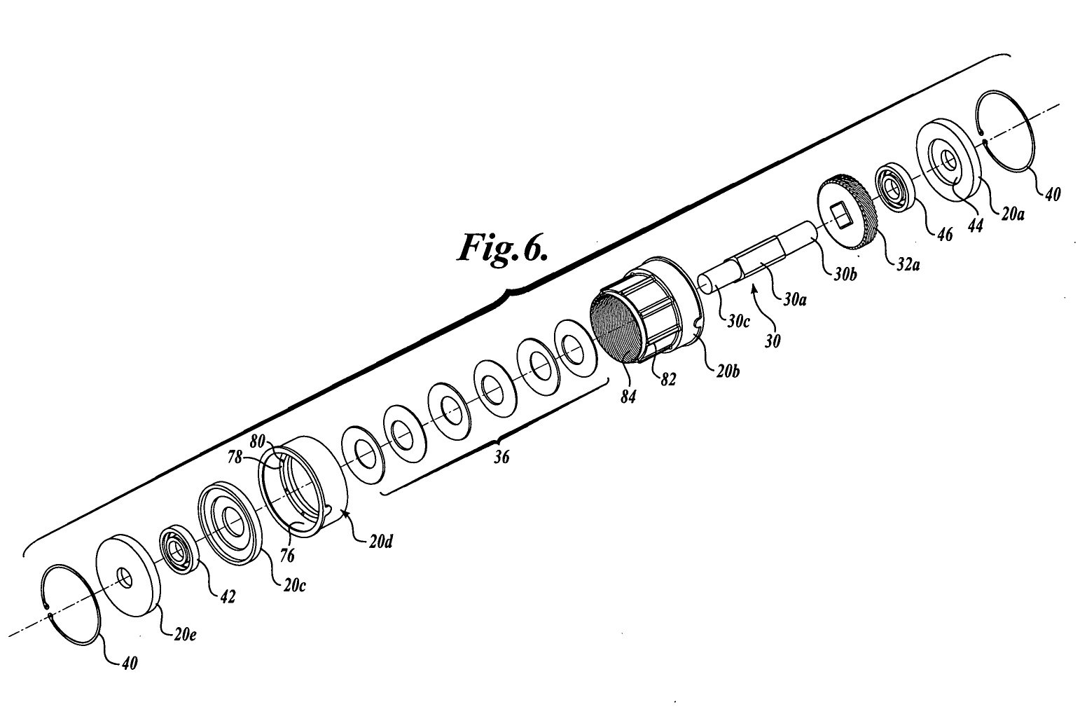

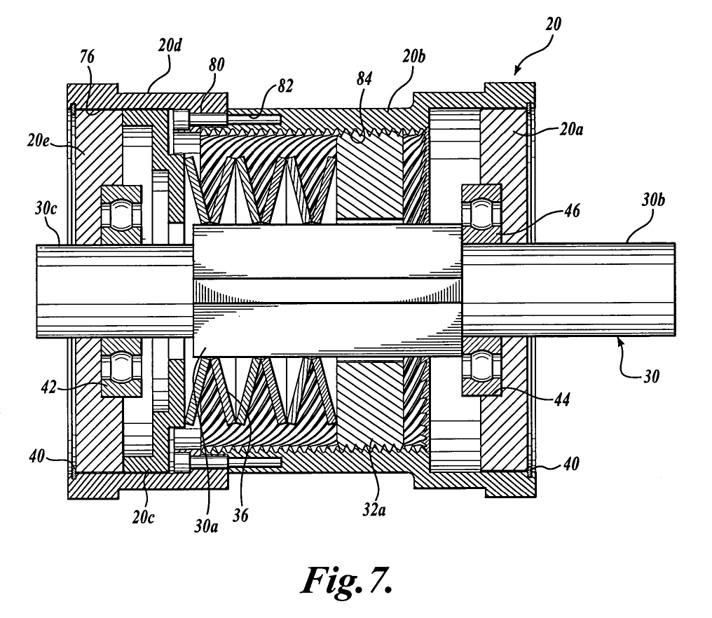

FIGS. 3 and 4 are isometric views of the external portion of the hub 20. Referring collectively to FIGS. 3-6, the hub 20 comprises four components: right-end wall 20a, right-half housing 20b, a spacer 20c, left-half housing 20d, and left-end wall 20e. The right-half housing 20b of the hub is a hollow shell having an enlarged diameter end portion 70 that forms an annular shoulder 72 on the interior. The right-end wall 20a fits in the enlarged region 70 and abuts against the shoulder 72. Similarly, the left-end wall 20e of the housing 20 has an increased diameter portion 76 terminating in a shoulder 78 against which the left-end wall 20e abuts. Retaining rings 40 abut against the outer surfaces of end walls 20a and 20e and fit in annular grooves (not shown) to hold the end walls 20a and 20e in place. The left-half housing 20d and the right-half housing 20b are joined so that they are oriented coaxially with each other. Fasteners (not shown) are inserted through apertures 80 in the left-half housing 20d into threaded openings 82 in the right-half housing 20b to securely fasten the two sections of the housing together.

Right-half housing 20b carries internal threads 84. The threads are right-handed when viewed from the right side of the housing 20b. In this embodiment, the shaft 30 is coaxially mounted in the housing portions 20b and 20d. Each of the end walls 20e and 20a carry a concentric axial bore that receives respectively the left end 30c of the shaft and the right end 30b of the shaft. The central portion 30a of the shaft 30 is square in cross section. A gear 32a with a square hole in the middle is slidably fitted onto the central, square portion 30a of the shaft 30. The external portion of the gear 32a has external threads that mate with the internal threads 84 on the right-half housing portion 20b. As the shaft rotates in a clockwise direction, the gear 32a will move axially from right to left within the right-half housing portion 20b as the gear 32a threads along internal threads 84. Shaft bearings 42 and 46 are provided and fit into shoulders 44 provided on the internal walls of the housing ends 20e and 20a of the housing 20. The shaft ends 30c and 30b are rotatably mounted in the bearings 42 and 46.

A spacer 20c is interposed in the left-half housing portions 20d. The left-side of the spacer 20c bears against the inner side of left-end wall and is shaped to clear the left bearing 46. The stack of Belleville washers bears against the internal right-hand wall of the spacer 20c and are compressed as the shaft 30b is rotated in a clockwise direction looking from the right side of the suspension mechanism. Thus, as the shaft 30 is rotated in a clockwise direction looking from the right, the internal threads 84 and the threads on the gear 32a intermesh so that the gear 32a will travel axially along the central, square portion 30a of the shaft 30 toward the spacer 20c, thus resiliently compressing the Belleville washers 36 against the wall of spacer 20c. The Belleville washers thus exert a reverse biasing force on the gear 32a so that when the torque on the shaft 30 causing the clockwise rotational motion is relieved, the Belleville washers will force the gear 32a in the opposite direction on the shaft 30, causing it to rotate in a counterclockwise direction (looking from the right) as it meshes with internal threads 84.

Thus, in this embodiment, the threads on the gear 32a and the internal threads 84 are a coacting cam mechanism that will exert a compression force on the Belleville washers 36 when the shaft 30 is rotated in one direction. The Belleville washers 36 will exert a biasing force on the gear 32a, which will cause the shaft 30 to rotate in a counter direction when the torque on shaft 30 is released. The Belleville washers function as an excellent spring and shock absorbing device. The Belleville washers can be provided so that each has a different spring rate, which will, for example, allow easy rotation through the first few degrees of motion and will gradually increase the resistive force because of an increased spring rate as the rotational travel is increased.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A rotary suspension system comprising:
a housing and a first suspended component affixed to said housing;
a shaft rotatably mounted in said housing and a second suspended component affixed to said shaft;
a first cam mounted on said shaft to rotate with said shaft;
a mating cam associated with said housing so as not to rotate with said shaft, one of said mating cam and said first cam being mounted for axial movement relative to the other when said first cam rotates with said shaft; and
a biasing element mounted in the housing and coacting with said one cam to resiliently resist axial movement of said mating cam upon rotation of said first cam.

2. The system of claim 1, wherein said biasing element comprises a spring.

3. The system of claim 2, wherein said spring comprises at least one Belleville spring compressible upon axial movement of said mating cam.

4. The system of claim 3, wherein said spring comprises a plurality of Belleville springs.

5. The system of claim 4, wherein at least one of said plurality of springs has a different spring constant from another of the plurality of springs.

6. The system of claim 4, wherein said mating cam comprises an internally threaded surface affixed to said housing, and said second cam comprises an externally threaded member mounted on said shaft for rotation therewith and for axial movement therealong, said plurality of springs acting against said first cam.

7. The system of claim 4, wherein said mating cam is mounted for axial sliding movement but not rotation in said housing, said plurality of springs acting against said mating cam.

8. The system of claim 1, wherein said first suspended component is the frame of a bicycle, and said second suspended component is a rear wheel support arm for a bicycle.
